(19) United States
(12) Patent Application Publication
(10) Pub. No.: US 2021/0192512 A1
(43) Pub. Date: Jun. 24, 2021

(54) METHOD AND APPARATUS FOR STORING AND OBTAINING MERCHANT AUTHENTICATION DATA IN BLOCKCHAIN NETWORK

(71) Applicant: Advanced New Technologies Co., Ltd., Grand Cayman (KY)

(72) Inventor: Huizi CHE, Hangzhou (CN)

(21) Appl. No.: 17/191,375

(22) Filed: Mar. 3, 2021

Related U.S. Application Data
(63) Continuation of application No. PCT/CN2019/106585, filed on Sep. 19, 2019.

(30) Foreign Application Priority Data
Nov. 14, 2018 (CN) 201811353554.4

(51) Int. Cl. G06Q 20/40; H04L 9/32; H04L 9/06

(52) U.S. Cl. CPC G06Q 20/40; H04L 2209/38; H04L 9/0618; H04L 9/3247

(57) ABSTRACT

Embodiments of this disclosure provide a method and an apparatus for storing merchant authentication data in a blockchain of a blockchain network, and a method and an apparatus for obtaining merchant authentication data from a blockchain of a blockchain network. The blockchain network includes a plurality of verification nodes and a plurality of usage nodes. The plurality of verification nodes correspond to various organizations issuing various types of authentication data, respectively. The method for storing merchant authentication data is performed on a first verification node of the plurality of verification nodes, including: obtaining authentication data of a merchant, the authentication data being issued by an organization corresponding to the first verification node; and broadcasting the authentication data to other verification nodes of the plurality of verification nodes in the blockchain network, so that the authentication data is verified based on a consensus mechanism and stored in the blockchain network in response to the verification of the authentication data succeeding.

### BACKGROUND

### Technical Field

Embodiments of this specification relate to the field of blockchain technologies, and more specifically, to a method and an apparatus for storing and obtaining merchant authentication data in a blockchain of a blockchain network.

### Description of the Related Art

Consumers often query credit and authentication data of category B merchants through the Internet platform. The conventional merchant authentication process is a serial interface invoking process. For example, if a platform serving as a user of authentication data wants to obtain merchant authentication data, the platform must invoke an authenticator's interface. After receiving a request, the authenticator initiates a request to a data broker. Then, the data broker invokes an interface of the administration for industry and commerce. As such, a result can be returned only when all nodes on the entire data link work normally. Moreover, each node on the link stores data locally. In addition, to ensure the authenticity of the data, the data of all nodes must be completely consistent to ensure that the data exposed by each node is correct. To ensure that the data of all nodes is consistent, if the data of some nodes is changed, these nodes need to actively notify other nodes of the change through an interface, or the other nodes need to actively obtain the data of other nodes for comparison.

Therefore, a more effective solution for merchant authentication is needed.

### BRIEF SUMMARY

Embodiments of this specification provide more effective technical solutions for storing and obtaining merchant authentication data in a blockchain of a blockchain network. The technical solution include technical advantages over existing technologies that, among others, solve the deficiencies of existing technologies.

An aspect of this disclosure provides a method for storing merchant authentication data in a blockchain of a blockchain network; the blockchain network includes a plurality of verification nodes and a plurality of usage nodes; the plurality of verification nodes correspond to various organizations issuing various types of authentication data, respectively; the method is performed on a first verification node of the plurality of verification nodes, including: obtaining authentication data of a merchant, the authentication data being issued by an organization corresponding to the first verification node; and broadcasting the authentication data to other verification nodes of the plurality of verification nodes in the blockchain network, so that the authentication data is verified based on a consensus mechanism and stored in the blockchain network in response to that verification of the authentication data succeeds.

In some embodiments, the authentication data includes one or more of image data or text data.

In some embodiments, the authentication data is stored in the blockchain network in association with a merchant identifier of the merchant in response to that verification of the authentication data succeeds.

In some embodiments, the authentication data is stored in the blockchain network in association with a node identifier of the first verification node in response to that verification of the authentication data succeeds.

In some embodiments, the verification is performed by using a smart contract deployed in the blockchain network, and the smart contract is jointly signed by the plurality of verification nodes.

In some embodiments, the verification includes verifying image data with respect to one or more of: a size of the image data, a resolution of the image data, content legality of the image data, content validity of the image data, or whether the image data has been modified.

In some embodiments, the verification includes verifying text data with respect to one or more of: a format or content validity of the text data.

In some embodiments, the broadcasting the authentication data to other verification nodes of the plurality of verification nodes in the blockchain network includes: broadcasting the authentication data and a digital signature of the first verification node to other verification nodes of the plurality of verification nodes in the blockchain network, where the verification includes verifying the digital signature.

An aspect of this specification provides a method for obtaining merchant authentication data from a blockchain of a blockchain network; the blockchain network includes a plurality of verification nodes and a plurality of usage nodes; the plurality of verification nodes correspond to various organizations issuing various types of authentication data, respectively; the method is performed on a first usage node of the plurality of usage nodes, including: obtaining all the blocks in the blockchain network, which store respective authentication data of a plurality of merchants, and the plurality of merchants include a first merchant; and retrieving at least one piece of authentication data of the first merchant from the blocks.

In some embodiments, the retrieving the at least one piece of authentication data of the first merchant from the blocks includes: establishing an index of the plurality of merchants for the blocks, and retrieving the at least one piece of authentication data of the first merchant based on the index.

In some embodiments, the retrieving the at least one piece of authentication data of the first merchant from the blocks includes: establishing a database of the authentication data for the blocks, and retrieving the at least one piece of authentication data of the first merchant based on the database, where the database includes an association relationship between the plurality of merchants and the authentication data.

In some embodiments, the database further includes an association relationship between the authentication data and a node identifier of a verification node corresponding to an organization issuing the authentication data, where the retrieving the at least one piece of authentication data of the first merchant from the blocks includes: retrieving, from the blocks, the at least one piece of authentication data of the first merchant and a node identifier of a verification node corresponding to an organization issuing each of the at least one piece of authentication data; and screening the at least one piece of authentication data based on the node identifier of the verification node corresponding to the organization issuing each of the at least one piece of authentication data.

In some embodiments, the database further includes an association relationship between the authentication data and a timestamp of a block at which the authentication data is located, where the retrieving the at least one piece of authentication data of the first merchant from the blocks includes: retrieving, from the blocks, the at least one piece of authentication data of the first merchant and a timestamp corresponding to each of the at least one piece of authentication data; and screening the at least one piece of authentication data based on the timestamp corresponding to each of the at least one piece of authentication data.

An aspect of this specification provides an apparatus for storing merchant authentication data in a blockchain of a blockchain network; the blockchain network includes a plurality of verification nodes and a plurality of usage nodes; the plurality of verification nodes correspond to various organizations issuing various types of authentication data, respectively; the apparatus is implemented on a first verification node of the plurality of verification nodes, including: an acquisition unit, configured to obtain authentication data of a merchant, the authentication data being issued by an organization corresponding to the first verification node; and a broadcast unit, configured to broadcast the authentication data to other verification nodes of the plurality of verification nodes in the blockchain network, so that the authentication data is verified based on a consensus mechanism and stored in the blockchain network in response to the verification of the authentication data succeeding.

In some embodiments, the broadcast unit is further configured to broadcast the authentication data and a digital signature of the first verification node to other verification nodes of the plurality of verification nodes in the blockchain network, where the verification includes verifying the digital signature.

An aspect of this specification provides an apparatus for obtaining merchant authentication data from a blockchain of a blockchain network; the blockchain network includes a plurality of verification nodes and a plurality of usage nodes; the plurality of verification nodes correspond to various organizations issuing various types of authentication data, respectively; the apparatus is implemented on a first usage node of the plurality of usage nodes, including: an acquisition unit, configured to obtain all the blocks in the blockchain network, which store respective authentication data of a plurality of merchants, and the plurality of merchants include a first merchant; and a retrieving unit, configured to retrieve at least one piece of authentication data of the first merchant from the blocks.

In some embodiments, the retrieving unit includes: an index establishment subunit, configured to establish an index of the plurality of merchants for the blocks; and a first retrieving subunit, configured to retrieve the at least one piece of authentication data of the first merchant based on the index.

In some embodiments, the retrieving unit includes: a database establishment subunit, configured to establish a database of the authentication data for the blocks, where the database includes an association relationship between the plurality of merchants and the authentication data; and a second retrieving subunit, configured to retrieve the at least one piece of authentication data of the first merchant based on the database.

In some embodiments, the database further includes an association relationship between the authentication data and a node identifier of a verification node corresponding to an organization issuing the authentication data, where the retrieving unit further includes a third retrieving subunit, configured to retrieve, from the blocks, the at least one piece of authentication data of the first merchant and a node identifier of a verification node corresponding to an organization issuing each of the at least one piece of authentication data; and a first screening subunit, configured to screen the at least one piece of authentication data based on the node identifier of the verification node corresponding to the organization issuing each of the at least one piece of authentication data.

In some embodiments, the database further includes an association relationship between the authentication data and a timestamp of a block at which the authentication data is located, where the retrieving unit further includes a fourth retrieving subunit, configured to retrieve, from the blocks, the at least one piece of authentication data of the first merchant and a timestamp corresponding to each of the at least one piece of authentication data; and a second screening subunit, configured to screen the at least one piece of authentication data based on the timestamp corresponding to each of the at least one piece of authentication data.

An aspect of this specification provides a computing device, including a memory and a processor, where the memory stores executable code, and the processor executes the executable code to implement any one of the above methods.

According to the merchant authentication solution in the embodiments of this specification, a blockchain-based peer-to-peer (p2p) network can be used to ensure that all nodes achieve data consistency in time, thereby solving the problem of data inconsistency caused by the conventional authentication process; the blockchain network records all authentication data changes, so that any authentication data change can be traced, thereby solving the problem that data cannot be traced in the conventional authentication process; in addition, a network structure and an operating mechanism of the blockchain network can ensure that the data of all nodes is synchronized at the second level, thereby solving the problem that the conventional authentication process is complicated and the data link is excessively long.

### BRIEF DESCRIPTION OF THE SEVERAL VIEWS OF THE DRAWINGS

To make embodiments of this specification clearer, the embodiments of this specification are described with reference to accompanying drawings.

FIG. 1 shows a blockchain-based authentication system 100 according to some embodiments of this specification;

FIG. 2 shows a method for storing merchant authentication data in a blockchain of a blockchain network according to some embodiments of this specification;

FIG. 3 shows a method for obtaining merchant authentication data from a blockchain of a blockchain network according to some embodiments of this specification;

FIG. 4 shows an apparatus 400 for storing merchant authentication data in a blockchain of a blockchain network according to some embodiments of this specification; and

FIG. 5 shows an apparatus 500 for obtaining merchant authentication data from a blockchain of a blockchain network according to some embodiments of this specification.

FIG. 6 is a diagram illustrating example environments that can be used to execute embodiments of this specification.

FIG. 7 is a diagram illustrating an example architecture in accordance with embodiments of this specification.

### DETAILED DESCRIPTION

The following describes the embodiments of this specification with reference to accompanying drawings.

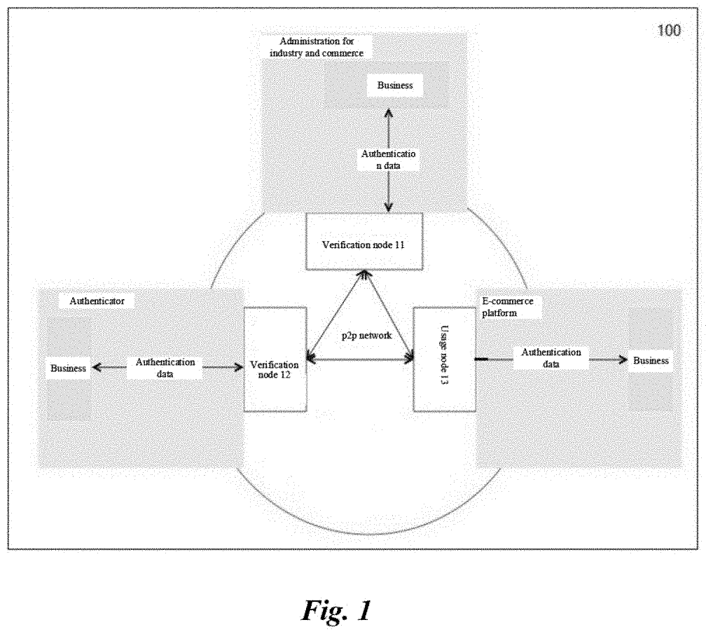

FIG. 1 shows a blockchain-based authentication system 100 according to some embodiments of this specification. As shown in FIG. 1, the system 100 is a blockchain network system, which includes a verification node 11, a verification node 12, and a usage node 13. It can be understood that although only three nodes are shown in the figure, these nodes are only illustrative, and the system 100 may include any number of verification nodes and usage nodes. The verification node 11 or 12 corresponds to an organization issuing merchant authentication data. For example, as shown in FIG. 1, the verification node 11 may correspond to an authority such as the administration for industry and commerce, and the verification node 12 may correspond to an authenticator. The authenticator may be a certification organization such as SGS, TUV Rheinland Group (TUV), etc. In the system 100, for example, after applying for a business license for a merchant through the relevant business of the administration for industry and commerce, the verification node 11 obtains authentication data corresponding to the business license (such as image data of the business license), and broadcasts the obtained authentication data to the blockchain network. A plurality of verification nodes in the system determine a mining node based on the consensus mechanism, and the mining node stores the authentication data in the blockchain network. For example, the mining node may be the verification node 12. After storing the authentication data in the blockchain network, the verification node 12 broadcasts to all nodes in the system 100, so that each node updates the local copy of the blockclain to ensure that the data of all the nodes is consistent. At the same time, the authenticator corresponding to the verification node 12 can also obtain the authentication data of the merchant through its own business operation, and similarly store the authentication data in the blockchain network through the verification node 12. The usage node 13 is a node that uses the authentication data stored in the blockchain network, and corresponds to an Internet e-commerce platform, for example. The platform includes a plurality of merchants and provides services for consumers. When a consumer of the platform queries authentication data of a merchant through the platform, the platform obtains all the blocks in the blockchain network through the usage node 13 and obtains the authentication data of the corresponding merchant from the blocks, so as to display the data to the consumer.

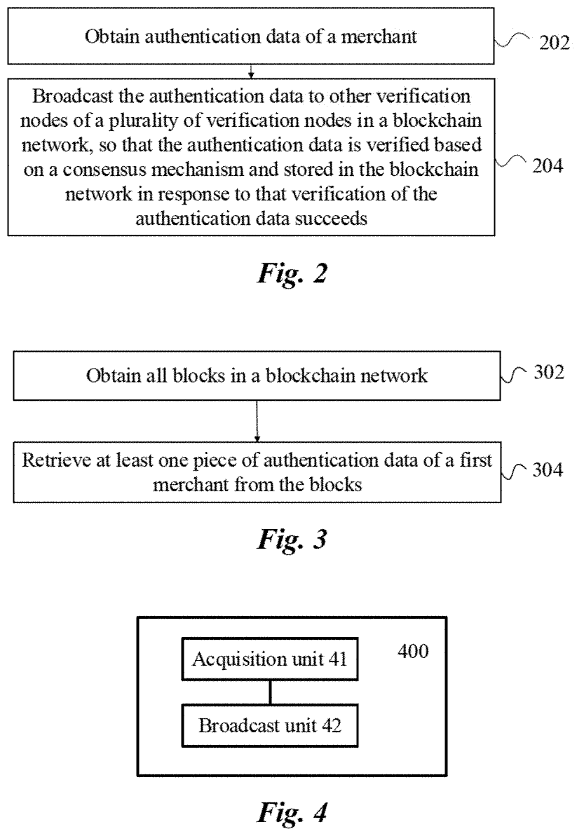

FIG. 2 shows a method for storing merchant authentication data in a blockchain of a blockchain network according to some embodiments of this specification. The blockchain network includes a plurality of verification nodes and a plurality of usage nodes. The plurality of verification nodes correspond to various organizations issuing various types of authentication data, respectively. The method is performed on a first verification node of the plurality of verification nodes, including the following steps:

Step S202: Obtain authentication data of a merchant, the authentication data being issued by an organization corresponding to the first verification node.

Step S204: Broadcast the authentication data to other verification nodes of the plurality of verification nodes in the blockchain network, so that the authentication data is verified based on a consensus mechanism and stored in the blockchain network in response to that verification of the authentication data succeeds.

In the embodiments of this specification, the blockchain is, for example, a consortium blockchain, which includes a plurality of verification nodes and a plurality of usage nodes. The verification node corresponds to an organization issuing authentication data. The organization is, for example, the administration for industry and commerce, which issues a business license for a merchant. The organization is alternatively a third-party certification organization, such as SGS or TUV, which issues various types of authentication data of the merchant, such as company certification data, product certification data, product testing information, etc. The usage node can obtain the authentication data of the merchant through the blockchain network, and the usage node does not participate in the verification and storage processes of the authentication data in the blockchain network.

First, in step 5202, the authentication data of the merchant is obtained, the authentication data being issued by an organization corresponding to the first verification node.

The method is performed on the first verification node, which corresponds to the administration for industry and commerce, for example. For example, a merchant can submit the required materials to the administration for industry and commerce and carry out the specified procedure, so that the administration for industry and commerce approves a business license for the merchant. After approving the business license, the administration for industry and commerce can obtain an image of the business license, so that the first verification node obtains the authentication data of the merchant corresponding to the business license. The first verification node may also be, for example, a third-party certification organization (such as SGS), which conducts door-to-door surveys on the merchant, tests the merchant's products, and so on, to obtain text data for authenticating the merchant. The text data includes, for example, a plurality of characteristics of the merchant, such as the merchant's business operation period and operation scale, etc. As such, the first verification node obtains the authentication data of the merchant corresponding to the text data. It can be understood that the authentication data may alternatively include both the image data and the text data. For example, the merchant authentication provided by a third-party certification organization may include a text description of the merchant and image data such as a business license.

In step S204, the authentication data is broadcast to other verification nodes in the blockchain network, so that the authentication data is verified based on a consensus mechanism and stored in the blockchain network in response to that verification of the authentication data succeeds.

After obtaining the authentication data of the merchant, the first verification node can use a private key to digitally sign the authentication data to make it clear that the issuer of the authentication data is the organization corresponding to the digital signature. Then, the first verification node broadcasts the authentication data and the digital signature to the plurality of verification nodes in the blockchain network, so that each verification node obtains the authentication data and the digital signature. For example, the first verification node can send the authentication data and the digital signature to a second verification node, and the second verification node verifies the digital signature of the first verification node by using a public key of the first verification node. In response to that verification of the authentication data succeeds, the second verification node sends the authentication data and the digital signature to a third verification node. The third verification node operates similarly to the second verification node. As such, the file is transmitted to each verification node in the blockchain network, and it is ensured that the initial authentication data has not been tampered with.

After obtaining the authentication data and the digital signature, the plurality of verification nodes determine a mining node based on a consensus mechanism. The consensus mechanism may be any consensus mechanism that can be obtained by a person skilled in the art. For example, the consensus mechanism includes, but is not limited to: proof of work (POW), proof of stake (POS), delegated proof of stake (DPOS), practical byzantine fault tolerance (PBFT), delegated byzantine fault tolerance (DBFT), etc. In some embodiments, PBFT and DPOS are used as consensus mechanisms in the consortium blockchain. It can be understood that the mining node determined based on a specific consensus mechanism may be another verification node other than the first verification node, or may be the first verification node itself.

In some embodiments, after obtaining the authentication data, each verification node puts the authentication data into the local to-be-accounted information pool. After consensus is reached, the mining node assembles a plurality of pieces of authentication data in the local to-be-accounted information pool and stores them in a block.

After the mining node is determined, the mining node verifies the locally received authentication data and digital signature. First, the mining node verifies whether the digital signature is the digital signature of the first verification node. Specifically, the mining node can decrypt the digital signature by using the public key of the first verification node that is obtained in advance or sent simultaneously with the authentication data from the first verification node, and compare the digital signature with the digest of the authentication data to determine whether the digital signature comes from the first verification node and whether the authentication data is tampered with.

As described above, the authentication data may be image data. In such case, in addition to verifying the digital signature, it can further be verified whether the form and content of the image meet the requirements. For example, it can be verified whether the size and resolution of the image meet the requirements, whether the content of the image is legal, whether the content shown in the image is correct, whether the image has been modified, and so on. The authentication data may alternatively be text data. In such case, it is verified whether the format and content of the text are valid. For example, if the text is the merchant's business operation period, whether the operation period is valid can be determined based on the existing authentication data of the merchant stored locally. Since each verification node is a node in the blockchain network, it has complete data in the blockchain network. Thus, each verification node can obtain the existing authentication data of the merchant from all the locally accessed ledgers of the blockchain, and determine on the content validity of the newly obtained authentication data based on the existing authentication data.

In some embodiments, a smart contract for verifying the authentication data is deployed in the blockchain network, and the smart contract is jointly signed by the plurality of verification nodes. The smart contract may include a plurality of clauses, and each clause corresponds to one specific verification action. For example, before verifying the authentication data, the mining node can invoke the smart contract locally to trigger the execution of the smart contract. After the smart contract starts to be executed, it receives the authentication data and digital signature, and verifies them based on the various clauses in the smart contract.

For example, when verifying the digital signature, the smart contract can obtain the pre-stored public key of the first verification node from the storage unit, and perform a calculation based on the algorithm of the digital signature to verify the digital signature.

For example, in response to determining that the authentication data is image data, the smart contract triggers its clauses related to the image data, such as determining the size of the image and determining whether the size of the image meets the requirements, determining the resolution of the image and determining whether the resolution of the image meets the requirements, and invoking the image detection model to detect the content of the image and determine whether the content meets the requirements, and so on. In addition, after obtaining the above determination result, the smart contract can automatically take a corresponding action based on the determination result. For example, in response to determining that the resolution of the image is insufficient, the smart contract automatically cancels the accounting and storage of the authentication data, and notifies the first verification node that after determining that the image meets the requirements, the first verification node can automatically perform accounting and storage of the authentication data, and so on.

For example, in response to determining that the authentication data is text data, the smart contract triggers its clauses related to the text data. For example, the smart contract may include a clause for verifying the text format. The clause compares the format of the text data with a determined, predetermined or dynamically determined, number of formats to determine whether the format of the text data meets a specified format. In response to the text data being submitted in a specified format, the smart contract can perform content verification based on a determined format. For example, the text is searched through a preset keyword library to determine which clause is triggered for the text. Each clause in the smart contract is used to design a specific verification algorithm for the specific content in the authentication data. For example, the smart contract may include a clause for verifying the merchant's business operation period. After determining that the text includes the keyword of the merchant's business operation period, the smart contract can obtain the number at the determined position in the text (e.g., the business operation period in the text), and compare the number with the existing information about the merchant's business operation period, to verify the content validity of the text. For example, the validity of the business operation period is determined by determining whether the number is the merchant's business operation period submitted last year plus one.

After completing the verifying of the authentication data, in response to that verification of the authentication data succeeds, the mining node generates a new block in the blockchain network based on the authentication data, that is, stores the authentication data as a block in the blockchain network. As described above, the mining node may assemble a plurality of pieces of authentication data to generate a block. After generating the new block, the mining node broadcasts the generation of the new block to the entire blockchain network, so that each node updates the local copy of the blockclain network.

During storage of the authentication data in the blockchain network, to facilitate information query, the authentication data can be stored in association with the merchant identifier. For example, the authentication data and the corresponding merchant can be stored in the form of a database. In some embodiments, the authentication data can alternatively be stored in association with the node identifier of the first verification node. For example, a column for the issuing organization identifier can be added to the database, so that the issuing organization corresponding to the authentication data can be quickly obtained. In some embodiments, the authentication data can alternatively be stored in association with the timestamp of the block at which the authentication data is located.

FIG. 3 shows a method for obtaining merchant authentication data from a blockchain of a blockchain network according to some embodiments of this specification. The blockchain network includes a plurality of verification nodes and a plurality of usage nodes. The plurality of verification nodes correspond to various organizations issuing various types of authentication data, respectively. The method is performed on a first usage node of the plurality of usage nodes, including the following steps:

Step S302: Obtain all the blocks in the blockchain network, which store respective authentication data of a plurality of merchants, the plurality of merchants including a first merchant.

Step S304: Retrieve at least one piece of authentication data of the first merchant from the obtained blocks.

First, in step 5302, all the blocks in the blockchain network are obtained, where the blocks store respective authentication data of a plurality of merchants, and the plurality of merchants include a first merchant. For the specific description of the blockchain network, references can be made to the above description, and details are omitted herein for simplicity. The first usage node may be any one of the plurality of usage nodes. As a node in the blockchain network, the usage node can access the complete data in the blockchain network and continuously update the locally stored blocks (data blocks), so that the locally stored blocks are kept consistent with the blocks in the blockchain network. As described above, the plurality of blocks store the authentication data of the merchant and the information associated with the authentication data, such as the related merchant, issuing organization, timestamp, etc. The blocks in the blockchain network continuously grow over time, and at the same time, the local copies of the blockchain stored at each node in the blockchain network are updated accordingly.

In step S304, at least one piece of authentication data of the first merchant is retrieved from the blocks.

In some embodiments, the first usage node locally performs a search in the plurality of blocks with the identifier of the first merchant as a keyword, to obtain at least one piece of authentication data of the first merchant. For example, the authentication data is text information, and the text information includes the identifier of the first merchant. Thus, the authentication data can be searched out through the identifier of the first merchant. For example, when the first merchant is stored in association with its authentication data, at least one piece of authentication data associated with the first merchant can be searched out by performing search with the identifier of the first merchant as a keyword.

In some embodiments, the first usage node can locally establish an index of each merchant for the blocks. For example, the index can sort merchants based on a certain order. For example, when the merchant identifier is the Chinese phonetic alphabet, the merchants can be sorted based on an alphabetical order, so that the first merchant can be easily found in the index and at least one piece of authentication data corresponding to the first merchant can be retrieved from the index.

In some embodiments, the first usage node can locally establish a database about the authentication data for the blocks. The database includes, for example, the association relationship between the plurality of merchants and the authentication data, the association relationship between the issuing organization and the authentication data, the association relationship between the authentication data and the timestamp of the block at which the authentication data is located, and so on. Thus, at least one piece of authentication data of the first merchant can be retrieved based on the database. After the at least one piece of authentication data is obtained, the timestamp and issuing organization corresponding to each of the at least one piece of authentication data can further be obtained based on the database, so that the at least one piece of authentication data can be screened based on one or more of the timestamp or the issuing organization. For example, three pieces of authentication data with most recent timestamps can be selected for output, or the authentication data issued by a designated organization (such as the administration for industry and commerce) can be selected for output.

FIG. 4 shows an apparatus 400 for storing merchant authentication data in a blockchain of a blockchain network according to some embodiments of this specification. The blockchain network includes a plurality of verification nodes and a plurality of usage nodes. The plurality of verification nodes correspond to various organizations issuing various types of authentication data, respectively. The apparatus is implemented on a first verification node of the plurality of verification nodes, including: an acquisition unit 41, configured to obtain authentication data of a merchant, the authentication data being issued by an organization corresponding to the first verification node; and a broadcast unit 42, configured to broadcast the authentication data to other verification nodes of the plurality of verification nodes in the blockchain network, so that the authentication data is verified based on a consensus mechanism and stored in the blockchain network in response to that verification of the authentication data succeeds.

In some embodiments, the broadcast unit 42 is further configured to broadcast the authentication data and a digital signature of the first verification node to other verification nodes of the plurality of verification nodes in the blockchain network, where the verification includes verifying the digital signature.

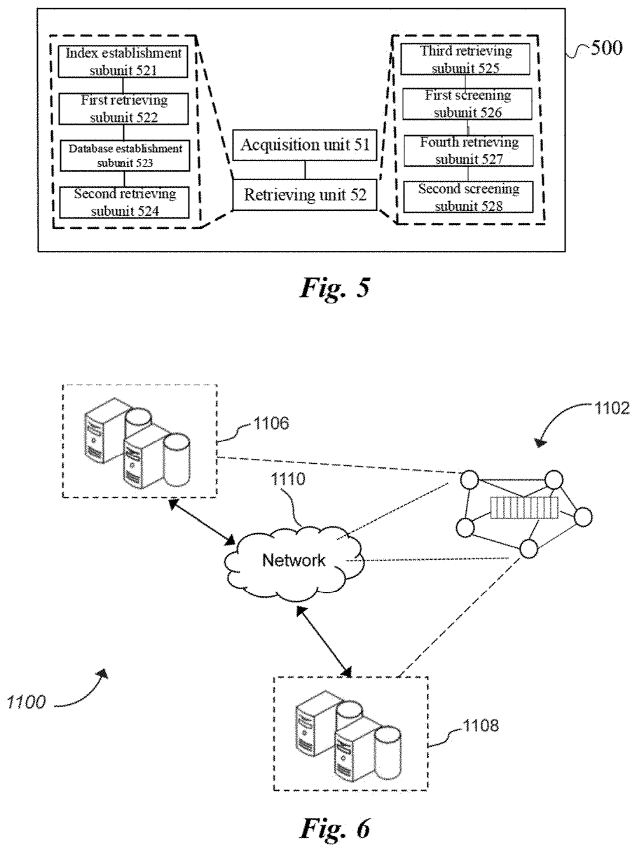

FIG. 5 shows an apparatus 500 for obtaining merchant authentication data from a blockchain of a blockchain network according to some embodiments of this specification. The blockchain network includes a plurality of verification nodes and a plurality of usage nodes. The plurality of verification nodes correspond to various organizations issuing various types of authentication data, respectively. The apparatus is implemented on a first usage node of the plurality of usage nodes, including: an acquisition unit 51, configured to obtain all the blocks in the blockchain network, which store respective authentication data of a plurality of merchants, and the plurality of merchants include a first merchant; and a retrieving unit 52, configured to retrieve at least one piece of authentication data of the first merchant from the blocks.

In some embodiments, the retrieving unit 52 includes: an index establishment subunit 521, configured to establish an index of the plurality of merchants for the blocks; and a first retrieving subunit 522, configured to retrieve the at least one piece of authentication data of the first merchant based on the index.

In some embodiments, the retrieving unit 52 includes: a database establishment subunit 523, configured to establish a database of the authentication data for the blocks, where the database includes an association relationship between the plurality of merchants and the authentication data; and a second retrieving subunit 524, configured to retrieve the at least one piece of authentication data of the first merchant based on the database.

In some embodiments, the database further includes an association relationship between the authentication data and a node identifier of a verification node corresponding to an organization issuing the authentication data, where the retrieving unit 52 further includes a third retrieving subunit 525, configured to retrieve, from the blocks, the at least one piece of authentication data of the first merchant and a node identifier of a verification node corresponding to an organization issuing each of the at least one piece of authentication data; and a first screening subunit 526, configured to screen the at least one piece of authentication data based on the node identifier of the verification node corresponding to the organization issuing each of the at least one piece of authentication data.

In some embodiments, the database further includes an association relationship between the authentication data and a timestamp of a block at which the authentication data is located, where the retrieving unit 52 further includes a fourth retrieving subunit 527, configured to retrieve, from the blocks, the at least one piece of authentication data of the first merchant and a timestamp corresponding to each of the at least one piece of authentication data; and a second screening subunit 528, configured to screen the at least one piece of authentication data based on the timestamp corresponding to each of the at least one piece of authentication data.

Another aspect of this specification provides a computing device, including a memory and a processor, where the memory stores executable code, and the processor executes the executable code to implement any one of the above methods.

According to the merchant authentication solution in the embodiments of this specification, a blockchain-based peer-to-peer (p2p) network can be used to ensure that all nodes achieve data consistency in time, thereby solving the problem of data inconsistency caused by the conventional authentication process; the blockchain network records all authentication data changes, so that any authentication data change can be traced, thereby solving the problem that data cannot be traced in the conventional authentication process; in addition, a network structure and an operating mechanism of the blockchain network can ensure that the data of all nodes is synchronized at the second level, thereby solving the problem that the conventional authentication process is complicated and the data link is excessively long.

The embodiments in this specification are described in a progressive way. For the same or similar parts of the embodiments, references can be made to the embodiments mutually. Each embodiment focuses on a difference from other embodiments. Particularly, some system embodiments are basically similar to some method embodiments, and therefore are described briefly. For related parts, references can be made to related descriptions in the method embodiments.

To provide further context for embodiments of this specification, and as introduced herein, distributed ledger systems (DLSs) (which can also be referred to as consensus networks, made up of peer-to-peer nodes), and blockchain networks, enable participating entities to securely, and immutably, conduct transactions and store data. Although the term blockchain is generally associated with particular networks, and/or use cases, blockchain is used herein to generally refer to a DLS without reference to any particular use case.

A blockchain is a data structure that stores transactions in a way that the transactions are immutable. Thus, the recording of transactions on a blockchain is reliable and trustworthy. A blockchain includes one or more blocks. Each block in the chain is linked to a previous block immediately before it in the chain by including a cryptographic hash of the previous block. Each block also includes a timestamp, its own cryptographic hash, and one or more transactions. Within a block, the transactions, which have already been verified by the nodes of the blockchain network, are hashed and encoded into a Merkle tree. The Merkle tree is a data structure in which each leaf node includes a hash on a corresponding transaction, and each non-leaf node includes a hash on the concatenation of the hashes in its children. . With this process continuing up the tree to the root of the entire tree, the root node includes a hash that is representative of all data in the tree. A hash purporting to be of a transaction stored in the tree can be quickly verified by determining whether it is consistent with the structure of the tree.

Where a blockchain is a decentralized or at least partially decentralized data structure for storing transactions, a blockchain network is a network of computing nodes that manage, update, and maintain one or more blockchains by broadcasting, verifying and validating transactions, etc. As introduced above, a blockchain network can be provided as a public blockchain network, a private blockchain network, or a consortium blockchain network. Embodiments of this specification are described in further detail herein with reference to a consortium blockchain network. However, embodiments of this specification can be realized in any appropriate type of blockchain network.

In general, a consortium blockchain network is private among the participating entities. In a consortium blockchain network, the consensus process is controlled by an authorized set of nodes, referred to as consensus nodes, one or more of which are operated by a respective entity (a financial institution, insurance company, etc.). For example, a consortium of ten (10) entities (financial institutions, insurance companies, etc.) can operate a consortium blockchain network, each of which operates at least one node in the consortium blockchain network.

In some examples, within a consortium blockchain network, a global blockchain is provided as a blockchain that is replicated across all nodes. That is, all consensus nodes are typically in perfect state consensus with respect to the global blockchain. To achieve consensus (agreement to the addition of a block to a blockchain), a consensus protocol or algorithm is implemented within the consortium blockchain network. For example, the consortium blockchain network can implement a practical Byzantine fault tolerance (PBFT) consensus, described in further detail below.

FIG. 6 is a diagram illustrating an example of an environment 1100 that can be used to execute embodiments of this specification. In some examples, the environment 1100 enables entities to participate in a consortium blockchain network 1102. The environment 1100 includes a plurality of computing devices 1106, 1108, and a network 1110. In some examples, the network 1110 includes a local area network (LAN), wide area network (WAN), the Internet, or a combination thereof, and connects web sites, user devices (computing devices), and back-end systems. In some examples, the network 1110 can be accessed over a wired and/or a wireless communications link. In some examples, the network 1110 enables communication with, and within the consortium blockchain network 1102. In general the network 1110 represents one or more communication networks. In some cases, the network 1110 includes network hardware such as switches, routers, repeaters, electrical cables and optical fibers, light emitters and receivers, radio transmitters and receivers, and the like. In some cases, the computing devices 1106, 1108 can be nodes of a cloud computing system (not shown), or each computing device 1106, 1108 can be a separate cloud computing system including a number of computers interconnected by a network and functioning as a distributed processing system.

In the depicted example, the computing systems 1106, 1108 can each include any appropriate computing system that enables participation as a node in the consortium blockchain network 1102. Examples of computing devices include, without limitation, a server, a desktop computer, a laptop computer, a tablet computing device, and a smartphone. In some examples, the computing systems 1106, 1108 host one or more computer-implemented services for interacting with the consortium blockchain network 1102. For example, the computing system 1106 can host computer-implemented services of a first entity (user A), such as a transaction management system that the first entity uses to manage its transactions with one or more other entities (other users). The computing system 1108 can host computer-implemented services of a second entity (user B), such as a transaction management system that the second entity uses to manage its transactions with one or more other entities (other users). In the example of FIG. 6, the consortium blockchain network 1102 is represented as a peer-to-peer network of nodes, and the computing systems 1106, 1108 provide nodes of the first entity and second entity, respectively, which participate in the consortium blockchain network 1102.

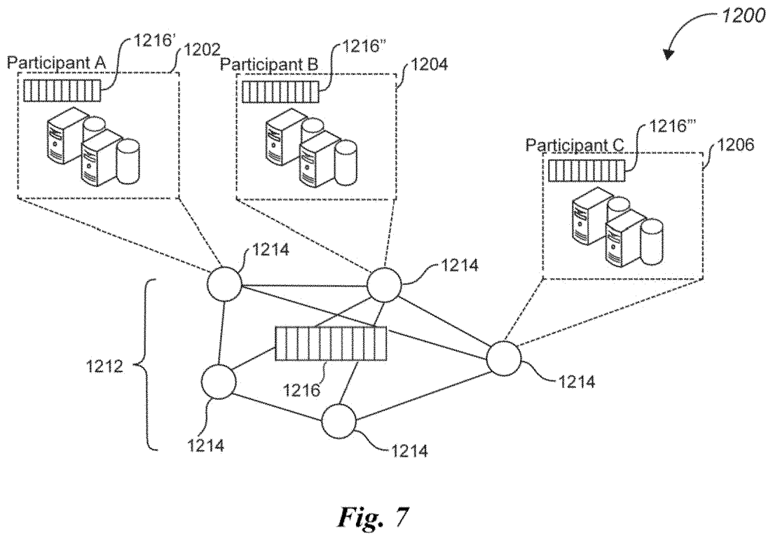

FIG. 7 depicts an example architecture 1200 in accordance with embodiments of this specification. The example architecture 1200 includes participant systems 1202, 1204, 1206 that correspond to Participant A, Participant B, and Participant C, respectively. Each participant (user, enterprise, etc.) participates in a blockchain network 1212 provided as a peer-to-peer network including a plurality of nodes 1214, at least some of which immutably record information in a blockchain 1216. Although a single blockchain 1216 is schematically depicted within the blockchain network 1212, multiple copies of the blockchain 1216 are provided, and are maintained across the blockchain network 1212, as described in further detail herein.

In the depicted example, each participant system 1202, 1204, 1206 is provided by, or on behalf of, Participant A, Participant B, and Participant C, respectively, and functions as a respective node 1214 within the blockchain network 1212. As used herein, a node generally refers to an individual system (computer, server, etc.) that is connected to the blockchain network 1212, and enables a respective participant to participate in the blockchain network. In the example of FIG. 7, a participant corresponds to each node 1214. It is contemplated, however, that a participant can operate multiple nodes 1214 within the blockchain network 1212, and/or multiple participants can share a node 1214. In some examples, the participant systems 1202, 1204, 1206 communicate with, or through, the blockchain network 1212 using a protocol (hypertext transfer protocol secure (HTTPS)), and/or using remote procedure calls (RPCs).

Nodes 1214 can have varying degrees of participation within the blockchain network 1212. For example, some nodes 1214 can participate in the consensus process (as miner nodes that add blocks to the blockchain 1216), while other nodes 1214 do not participate in the consensus process. As another example, some nodes 1214 store a complete copy of the blockchain 1216, while other nodes 1214 only store copies of portions of the blockchain 1216. For example, data access privileges can limit the blockchain data that a respective participant stores within its respective system. In the example of FIG. 7, the participant systems 1202, 1204 store respective, complete copies 1216′, 1216″, 1216′″ of the blockchain 1216. In the descriptions herein, nodes 1214 of the blockchain network 1212 are also referred to as “participant user” for descriptive purposes. In some embodiments, some or all of the participant users 1214 participate in the consensus process and are referred to as “consensus nodes”. The consensus nodes for the blockchain 1216 may also include other nodes not selected from the participant users 1214. In some other embodiments, consensus nodes for adding blocks to the blockchain 1216 do not overlap with the participant users 1214 that propose blocks to be added to the blockchain 1216.

A blockchain, such as the blockchain 1216 of FIG. 7, is made up of a chain of blocks, each block storing data. Examples of data include transaction data representative of a transaction between two or more participants. While transactions are used herein by way of non-limiting example, any appropriate data can be stored in a blockchain (documents, images, video, audio, etc.). Examples of a transaction can include, without limitation, exchanges of something of value (assets, products, services, currency, etc.) or occurrence of some events or activities. The transaction data is immutably stored within the blockchain. That is, an undetectable change cannot be made to the transaction data.

Before being stored in a block, the transaction data is hashed. Hashing is a process of transforming the transaction data, typically provided as string data, into a fixed-length hash value, typically provided as string data. It is not possible to un-hash the hash value to obtain the transaction data. Hashing ensures that even a slight change in the transaction data results in a completely different hash value. Further, and as noted above, the hash value is of a fixed length. That is, no matter the size of the transaction data the length of the hash value is fixed. Hashing includes processing the transaction data through a hash function to generate the hash value. An example of a hash function includes, without limitation, the secure hash algorithm (SHA)-256, which outputs 256-bit hash values.

Transaction data of multiple transactions are hashed and stored in a block. For example, hash values of two transactions are provided, and are themselves hashed to provide another hash. This process is repeated until, for all transactions to be stored in a block, a single hash value is provided. This hash value is referred to as a Merkle root hash, and is stored in a header of the block. A change in any of the transactions will result in change in its hash value, and ultimately, a change in the Merkle root hash.

Blocks are added to the blockchain through a consensus protocol. Multiple nodes within the blockchain network participate in the consensus protocol, and perform work to have a block added to the blockchain. Such nodes are referred to as consensus nodes. PBFT, introduced above, is used as a non-limiting example of a consensus protocol. The consensus nodes execute the consensus protocol to add transactions to the blockchain, and update the overall state of the blockchain network.

In further detail, for example, the consensus node generates a block header, hashes all of the transactions in the block, and combines the hash value in pairs to generate further hash values until a single hash value is provided for all transactions in the block (the Merkle root hash). This Merkle root hash is added to the block header. The consensus node also determines the hash value of the most recent block in the blockchain (the last block added to the blockchain) and adds the hash value of the most recent block into the block header. The consensus node also adds a nonce value, and a timestamp to the block header. The block header is hashed, which becomes the hash value of the block.

In general, PBFT provides a practical Byzantine state machine replication that tolerates Byzantine faults (malfunctioning nodes, malicious nodes, etc.). This is achieved in PBFT by assuming that faults will occur (assuming the existence of independent node failures, and/or manipulated messages sent by consensus nodes). In PBFT, the consensus nodes are provided in a sequence that includes a primary consensus node and backup consensus nodes. The primary consensus node is periodically changed. Transactions are added to the blockchain by all consensus nodes within the blockchain network reaching an agreement as to the world state of the blockchain network. In this process, messages are transmitted between consensus nodes, and each consensus nodes proves that a message is received from a specified peer node and verifies that the message was not modified during transmission.

In PBFT, the consensus protocol is provided in multiple phases with all consensus nodes beginning in the same state. To begin, a client sends a request to the primary consensus node to invoke a service operation (execute a transaction within the blockchain network). In response to receiving the request, the primary consensus node multicasts the request to the backup consensus nodes. The backup consensus nodes execute the request, and each sends a reply to the client. The client waits until a threshold number of replies are received. In some examples, the client waits for f+1 replies to be received, where f is the maximum number of faulty consensus nodes that can be tolerated within the blockchain network. The final result is that a sufficient number of consensus nodes come to an agreement on the order of the record that is to be added to the blockchain, and the record is either accepted, or rejected.

A consensus algorithm refers to a specific mechanism or terms, based on which a transaction or a block is verified and validated to be added into a blockchain. To that extent, a consensus algorithm is viewed as a specific implementation agreement adapted to follow rules of a consensus protocol. Different consensus algorithms may be created for different blockchain networks 1212 or different blockchains 1216, which all comply with a same consensus protocol.

In some blockchain networks, cryptography is implemented to maintain privacy of transactions. For example, if two nodes want to keep a transaction private, such that other nodes in the blockchain network cannot discern details of the transaction, the nodes can encrypt the transaction data. An example of cryptography includes, without limitation, symmetric encryption and asymmetric encryption. Symmetric encryption refers to an encryption process that uses a single key for both encryption (generating ciphertext from plaintext), and decryption (generating plaintext from ciphertext). In symmetric encryption, the same key is available to multiple nodes, so each node can encrypt/decrypt transaction data.

Asymmetric encryption uses keys pairs that each include a private key, and a public key, the private key being known only to a respective node, and the public key being known to any or all other nodes in the blockchain network. A node can use the public key of another node to encrypt data, and the encrypted data can be decrypted using other node's private key. For example, and referring again to FIG. 7, Participant A can use Participant B′s public key to encrypt data, and send the encrypted data to Participant B. Participant B can use its private key to decrypt the encrypted data (ciphertext) and extract the original data (plaintext). Messages encrypted with a node's public key can only be decrypted using the node's private key.

Asymmetric encryption is used to provide digital signatures, which enables participants in a transaction to confirm other participants in the transaction, as well as the validity of the transaction. For example, a node can digitally sign a message, and another node can confirm that the message was sent by the node based on the digital signature of Participant A. Digital signatures can also be used to ensure that messages are not tampered with in transit. For example, and again referencing FIG. 7, Participant A is to send a message to Participant B. Participant A generates a hash of the message, and then, using its private key, encrypts the hash to provide a digital signature as the encrypted hash. Participant A appends the digital signature to the message, and sends the message with digital signature to Participant B. Participant B decrypts the digital signature using the public key of Participant A, and extracts the hash. Participant B hashes the message and compares the hashes. If the hashes are same, Participant B can confirm that the message was indeed from Participant A, and was not tampered with.

In some embodiments, a logistics management system can be implemented within the blockchain environment 1100 of FIG. 6 and using the blockchain architecture 1200 of FIG. 7. For example, transaction information of a logistic process is stored as blocks in the blockchain 1216.

The specific embodiments of this specification are described previously. Other embodiments fall within the scope of the appended claims. In some situations, the actions or steps described in the claims can be performed in an order different from the order in the embodiments and the desired results can still be achieved. In addition, the process depicted in the accompanying drawings does not necessarily need a particular execution order to achieve the desired results. In some implementations, multi-tasking and concurrent processing are feasible or may be advantageous.

A person of ordinary skill in the art can be further aware that, with reference to the examples described in the embodiments disclosed in this specification, units and algorithm steps can be implemented by electronic hardware, computer software, or a combination thereof. To clearly describe interchangeability between the hardware and the software, compositions and steps of each example are generally described above based on functions. Whether the functions are performed by hardware or software depends on particular applications and design constraints of the technical solutions. A person of ordinary skill in the art can use different methods to implement the described functions for each particular application, but it should not be considered that the implementation goes beyond the scope of this application.

The steps in the method or algorithm described in the embodiments disclosed in this specification may be implemented by hardware, a software module executed by the processor, or a combination of hardware and software. The software module can reside in a random access memory (RAM), a memory, a read-only memory (ROM), an electrically programmable ROM, an electrically erasable programmable ROM, a register, a hard disk, a removable magnetic disk, a CD-ROM, or any other form of storage medium known in the art.

In the specific embodiments described above, the objective, technical solutions, and beneficial effects of the present invention are further described in detail. It should be understood that the above descriptions are merely specific embodiments of the present invention, but are not intended to limit the protection scope of the present invention. Any modification, equivalent replacement, or improvement made without departing from the spirit and principle of the present invention should fall within the protection scope of the present invention.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for storing merchant authentication data in a blockchain of a blockchain network, the blockchain network including a plurality of verification nodes and a plurality of usage nodes, comprising:
at a first verification node of the plurality of verification nodes,
obtaining authentication data of a first merchant, the authentication data being issued by a first organization corresponding to the first verification node;
broadcasting the authentication data to a second verification node of the plurality of verification nodes in the blockchain network for the second verification node to verify the authentication data based on a consensus mechanism and store the authentication data in a copy of the blockchain at the second verification node in response to that verification of the authentication data succeeds; and
storing the authentication data in a copy of the blockchain at the first verification node.

2. The method according to claim 1, wherein the authentication data includes one or more of image data or text data.

3. The method according to claim 1, wherein the authentication data is stored in a copy of the blockchain in association with a merchant identifier of the merchant in response to that verification of the authentication data succeeds.

4. The method according to claim 1, wherein the authentication data is stored in a copy of the blockchain in association with a node identifier of the first verification node in response to that the verification of the authentication data succeeds.

5. The method according to claim 1, wherein the verification is performed by using a smart contract deployed in the blockchain network, and the smart contract is jointly signed by the plurality of verification nodes.

6. The method according to claim 1, wherein the verification includes verifying image data of the authentication data with respect to one or more of: a size of the image data, a resolution of the image data, content legality of the image data, content validity of the image data, or whether the image data has been modified.

7. The method according to claim 1, wherein the verification includes verifying text data of the authentication data with respect to one or more of: a format or content validity of the text data.

8. The method according to claim 1, wherein the broadcasting the authentication data to the second verification node of the plurality of verification nodes in the blockchain network includes: broadcasting the authentication data and a digital signature of the first verification node to the second verification node of the plurality of verification nodes in the blockchain network, the verification including verifying the digital signature.

9. The method of claim 1, comprising:
at a first usage node of the plurality of usage nodes,
obtaining blocks of the blockchain in the blockchain network, the blocks storing respective authentication data of a plurality of merchants, and the plurality of merchants including the first merchant; and
retrieving at least one piece of authentication data of the first merchant from the blocks.

10. The method according to claim 9, wherein the retrieving the at least one piece of authentication data of the first merchant from the blocks includes: establishing an index of the plurality of merchants for the blocks, and retrieving the at least one piece of authentication data of the first merchant based on the index.

11. The method according to claim 9, wherein the retrieving the at least one piece of authentication data of the first merchant from the blocks includes: establishing a database of the authentication data for the blocks, and retrieving the at least one piece of authentication data of the first merchant based on the database, the database including an association relationship between the plurality of merchants and the authentication data.

12. The method according to claim 11, wherein the database further includes an association relationship between the authentication data and a node identifier of a verification node corresponding to an organization issuing the authentication data, and the retrieving the at least one piece of authentication data of the first merchant from the blocks includes: retrieving, from the blocks, the at least one piece of authentication data of the first merchant and a node identifier of a verification node corresponding to an organization issuing each of the at least one piece of authentication data; and screening the at least one piece of authentication data based on the node identifier of the verification node corresponding to the organization issuing each of the at least one piece of authentication data.

13. The method according to claim 11, wherein the database further includes an association relationship between the authentication data and a timestamp of a block at which the authentication data is located, and the retrieving the at least one piece of authentication data of the first merchant from the blocks includes: retrieving, from the blocks, the at least one piece of authentication data of the first merchant and a timestamp corresponding to each of the at least one piece of authentication data; and screening the at least one piece of authentication data based on the timestamp corresponding to each of the at least one piece of authentication data.

14. A computing system, comprising a memory and a processor, the memory storing executable code, and the processor executing the executable code to implement acts of a first verification node of a plurality of verification codes of a block chain network, the acts including:
obtaining authentication data of a merchant, the authentication data being issued by a first organization corresponding to the first verification node;
broadcasting the authentication data to a second verification node of the plurality of verification nodes in the blockchain network for the second verification node to verify the authentication data based on a consensus mechanism and store the authentication data in a copy of the blockchain at the second verification node in response to that verification of the authentication data succeeds; and
storing the authentication data in a copy of the blockchain at the first verification node.

15. The computing system according to claim 14, wherein the authentication data includes one or more of image data or text data.

16. The computing system according to claim 14, wherein the authentication data is stored in a copy of the blockchain in association with a merchant identifier of the merchant in response to that verification of the authentication data succeeds.

17. The computing system according to claim 14, wherein the authentication data is stored in a copy of the blockchain in association with a node identifier of the first verification node in response to that the verification of the authentication data succeeds.

18. The computing system according to claim 14, wherein the verification is performed by using a smart contract deployed in the blockchain network, and the smart contract is jointly signed by the plurality of verification nodes.

19. The computing system according to claim 14, wherein the verification includes one or more of:
verifying image data of the authentication data with respect to one or more of: a size of the image data, a resolution of the image data, content legality of the image data, content validity of the image data, or whether the image data has been modified; or
verifying text data of the authentication data with respect to one or more of: a format or content validity of the text data.

20. An apparatus for storing merchant authentication data in a blockchain of a blockchain network, the blockchain network including a plurality of verification nodes and a plurality of usage nodes, and the apparatus being implemented on a first verification node of the plurality of verification nodes, comprising:
an acquisition unit, configured to obtain authentication data of a merchant, the authentication data being issued by a first organization corresponding to the first verification node; and
a broadcast unit, configured to broadcast the authentication data to a second verification node of the plurality of verification nodes in the blockchain network for the second verification node to verify the authentication databased on a consensus mechanism and store the authentication data in a copy of the blockchain at the second verification node in response to that verification of the authentication data succeeds.
